(19) United States
(12) Patent Application Publication
(10) Pub. No.: US 2018/0154683 A1
(43) Pub. Date: Jun. 7, 2018

(54) Scratch-Off Tool

(71) Applicant: Nicole McFadden, Clearwater, MN (US)

(72) Inventor: Nicole McFadden, Clearwater, MN (US)

(21) Appl. No.: 15/816,685

(22) Filed: Nov. 17, 2017

Related U.S. Application Data
(60) Provisional application No. 62/423,548, filed on Nov. 17, 2016.

(51) Int. Cl. B43K 29/18; B08B 1/00; G07F 17/32

(52) U.S. Cl. CPC B43K 29/18; G07F 17/329; B08B 1/005

(57) ABSTRACT

A lottery scratch-off tool includes a main body into which a wooden scratch-off tool may be fitted such as with a pen to retract the beveled wooden tip until ready to use.

### CROSS-REFERENCE TO RELATED APPLICATIONS

This application claims priority to U.S. Provisional Patent Application Ser. No. 62/423,548 filed Nov. 17, 2016 which is incorporated by reference herein in its entirety.

### STATEMENT REGARDING FEDERALLY SPONSORED RESEARCH OR DEVELOPMENT

Not Applicable.

### BACKGROUND OF THE INVENTION

This invention relates to a tool to be used in scratch-off games to scratch off the material to expose the winning numbers or letters without damaging a possibly winning entry.

Currently, people use whatever they can find to remove the ink obscuring the numbers or letters. Keys, coins, credit cards, knife edges and the like are being used.

Lottery tickets are made up from paper and scratchable/removable ink, and require some care while scratching. If an individual is not careful the individual may inadvertently remove or damage some of the underlying numbers or markings, causing damage to the ticket. When the ticket is damaged it may need to be mailed into the appropriate gaming authority for verification and payment.

Lotteries have come up with a couple scratch tools like a small plastic card and a mini ice scraper. Both being very small and hard to hold. The known devices also do not work very well. The plastic becomes dull within a very short period time. Many other common objects are used by individuals as scratch off tools, such as car keys, pocket knives, credit cards, and coins. All have a very good chance of damaging the ticket and are difficult to hold or grasp.

Some lottery tickets have become quite lengthy. Some lottery tickets have numerous games on a ticket consisting of the front and back. Many individuals after one minute of attempting to scratch off all of the tiny little boxes on the ticket experience hand fatigue and pain or discomfort. These lottery ticket games are intended to be fun and have the participant focusing on the excitement of winning the jackpot, not trying to find a better tool to scratch a ticket, or looking for a more comfortable hand position.

All known scratch devices are unsatisfactory since they provide inconsistent results and may be too aggressive in the removal of the underlying numbers or markings or letters voiding the lottery ticket. Others have tried to solve this dilemma such as in U.S. Pat. No. 8,627,536.

The art described in this section is not intended to constitute an admission that any patent, publication or other information referred to herein is “prior art” with respect to this invention, unless specifically designated as such. In addition, this section should not be construed to mean that a search has been made or that no other pertinent information as defined in 37 C.F.R. § 1.56(a) exists.

### BRIEF SUMMARY OF THE INVENTION

The invention provides a lottery ticket scratch tool that is comfortable to hold, and does not become dull during use. It will not damage the ticket, even with excessive pressure. In some embodiments a basic retractable pen may be modified where the ink tube is replaced with a wooden stick element. The wooden stick element may be rounded and sized to fit within the pen casing in a manner which is the same as the way the ink tube does. The wooden stick element may have a tapered tip with a slight angle added to one side.

Plastic tips failed to provide the feel and performance of a wooden tip. The use of the body and mechanism of a retractable pen is to protect the tip from potential damage, and when someone is searching, say thru a purse, the individual will not inadvertently receive a minor poke in the hand. The scratcher portion of the invention is by no means sharp and would cause no more injury than a basic pen. The shape or sharpness of the wooden tip may be modified by the individual using it with a simple nail file or a piece of sandpaper to better suit their personal preference.

The invention may be provided in many different versions, such as a key chain style pen scratcher, just a smaller version of the original pen type scratcher with a small chain and a ring which attaches to a key ring for easy access. A dual tip pen and scratcher, where there are two different retractable buttons on the top of the pen and one is the scratcher and the other is a basic pen. Comfort grip, which is a rubber cushion around the barrel of the pen body where the body is held by an individual. The barrel of the pen body can also be imprinted with advertising and used promotionally.

### BRIEF DESCRIPTION OF THE DRAWINGS

A detailed description of the invention is hereafter described with specific reference being made to the drawings in which:

FIG. 1 is a side view of the device showing the main body and extended scratch-off tip;

FIG. 2 is an enlarged view of the extended scratch-off tip showing the beveled tip; and

FIG. 3 is a disassembled view showing the device taken apart.

### DETAILED DESCRIPTION OF THE INVENTION

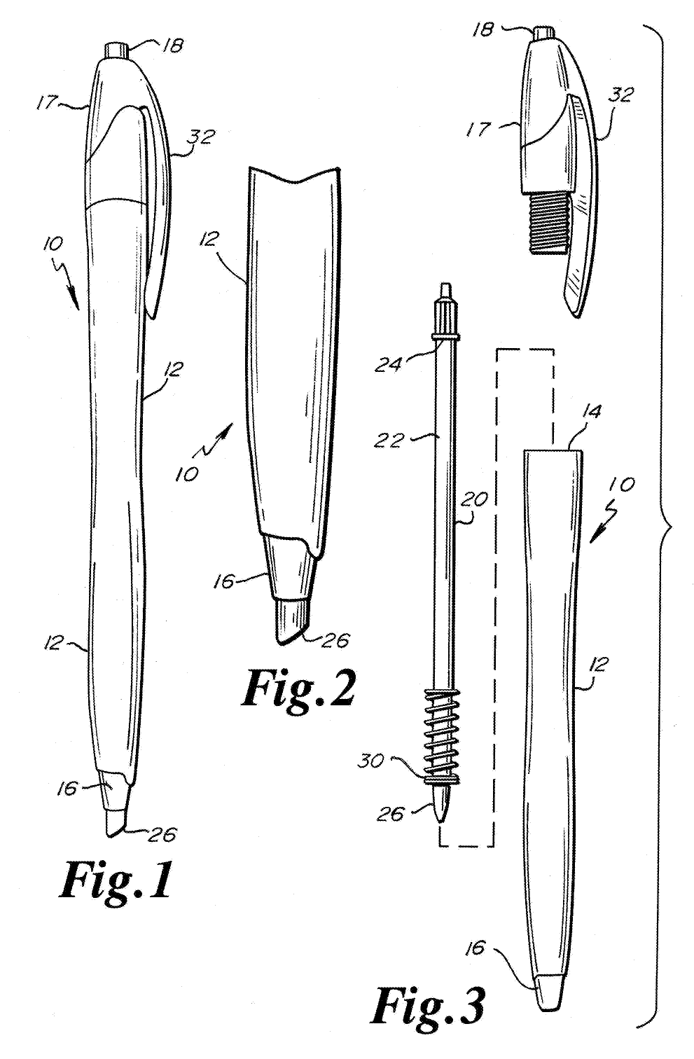

In FIG. 1 the scratch-off tool 10 is shown which may be in the form of a conventional pen having a barrel 12 with a threaded upper end 14 and a lower opening 16. The threaded upper end 14 is closed off by a conventional barrel body closure 17 which may include a push button mechanism 18 for extension and retraction. The scratching-off is accomplished via an elongated wood member 20 which has an elongated shaft 22 with an upper end 24 that contacts the push button mechanism 18 and a lower beveled tip 26 that can extend from the lower opening 16. The beveled tip 26 provides a relatively sharp edge which is perfect for removing the ink on a lottery ticket or the like without being too aggressive and damaging the underlying numbers and/or letters. It has been found that a conventional wooden cuticle pusher may be an acceptable elongated wood member 20.

A conventional spring 30 may be used to retract the wood member 20 as desired. It has been found that wood provides an ideal combination of features of being hard, holding an edge and not being too hard to be used for a scratch-off tool. Simply having a spare wooden cuticle pusher in a pocket is not acceptable since it would have a relatively sharp tip and would break or get lost, let alone poking a hole in a pocket.

The inventive scratch-off tool 10 either with or without a pocket clip 32 is always available to the user and can be attractive to carry.

The invention may also be made as a key chain pen device rather than a full length pen device. It may also have two click buttons with one supplying an actual pen and the other the scratch tool. Multiple ink color pens are well known and one of the colors may be replaced with the scratch off tool. Examples are found in U.S. Pat. Nos. 3,797,945; 3,164,132; 4,185,933, the disclosures of which are incorporated herein by reference.

In a first embodiment a scratch-off tool for lottery tickets includes a hollow barrel body having a threaded end and a scratch-off tip end, a barrel body closure for threading onto the hollow barrel body threaded end, an elongated wooden member sized to be received and held within the hollow barrel body with an end having a beveled tip, the beveled tip protruding from the scratch-off end of the hollow barrel body.

In a second embodiment according to the first embodiment, the scratch-off further comprises a spring disposed between the elongated wooden member and an inside surface of the hollow barrel body wherein the elongated wooden member may selectively be entirely within the hollow barrel body or exposing the beveled tip from the hollow barrel body for scratching of the lottery ticket.

In a third alternative embodiment according to the first alternative embodiment, the scratch-off tool further comprises a writing element housed within the hollow barrel body, wherein the writing element may be selectively extended from the hollow barrel body, wherein the elongated wooden member is retained within an inside of the hollow barrel body.

In a fourth alternative embodiment according to the second alternative embodiment, the scratch-off tool further comprises a writing element housed within the hollow barrel body, wherein the writing element may be selectively extended from the hollow barrel body, wherein the elongated wooden member is retained within an inside of the hollow barrel body.

While this invention may be embodied in many different forms, there are shown in the drawings and described in detail herein specific preferred embodiments of the invention. The present disclosure is an exemplification of the principles of the invention and is not intended to limit the invention to the particular embodiments illustrated.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

This completes the description of the preferred and alternate embodiments of the invention. Those skilled in the art may recognize other equivalents to the specific embodiment described herein which equivalents are intended to be encompassed by the claims attached hereto.

1. A scratch-off tool for lottery tickets comprising:
a) a hollow barrel body having a threaded end and a scratch-off tip end;
b) a barrel body closure for threading onto said hollow barrel body threaded end;
c) an elongated wooden member sized to be received and held within said hollow barrel body with an end having a beveled tip, said beveled tip protruding from the scratch-off end of said hollow barrel body.

2. The scratch-off tool of claim 1, further comprising a spring disposed between said elongated wooden member and an inside surface of said hollow barrel body wherein said elongated wooden member may selectively be entirely within said hollow barrel body or exposing the beveled tip from said hollow barrel body for scratching of said lottery ticket.

3. The scratch-off tool of claim 1, further comprising a writing element housed within the hollow barrel body, wherein said writing element may be selectively extended from said hollow barrel body, wherein said elongated wooden member is retained within an inside of said hollow barrel body.

4. The scratch-off tool of claim 2, further comprising a writing element housed within the hollow barrel body, wherein said writing element may be selectively extended from said hollow barrel body, wherein said elongated wooden member is retained within an inside of said hollow barrel body.
